(19) United States
(12) Patent Application Publication
(10) Pub. No.: US 2024/0067030 A1
(43) Pub. Date: Feb. 29, 2024

(54) POWERNET DOMAIN CONTROLLER AND VEHICLE HAVING THE SAME

(71) Applicants: HYUNDAI MOTOR COMPANY, Seoul (KR); KIA CORPORATION, Seoul (KR)

(72) Inventor: Munsoon KWON, Yongin-si (KR)

(73) Assignees: Hyundai Motor Company, Seoul (KR); KIA CORPORATION, Seoul (KR)

(21) Appl. No.: 18/208,526

(22) Filed: Jun. 12, 2023

(30) Foreign Application Priority Data
Aug. 30, 2022 (KR) 10-2022-0108846

(51) Int. Cl. B60L 53/64; B60L 53/62; B60L 58/12

(52) U.S. Cl. CPC B60L 53/64; B60L 53/62; B60L 58/12

(57) ABSTRACT

A vehicle including a powernet domain controller controlling power supplied to a load includes a first load configured to be applied with a first voltage; a second load configured to be applied with a second voltage lower than the first voltage; a temperature controller configured to control an operation of the first load and the second load; an inputter configured to receive a user input; a battery management system configured to manage a state of charge (SOC) value of a battery; and a powernet domain controller configured for determining whether to activate a power saving mode based on the SoC value, and when the power saving mode is activated, transmit an output reduction command of the first load and an output increase command of the second load to the temperature controller.

### CROSS-REFERENCE TO RELATED APPLICATION

The present application claims priority to Korean Patent Application No. 10-2022-0108846, filed on Aug. 30, 2022, the entire contents of which is incorporated herein for all purposes by this reference.

### BACKGROUND OF THE PRESENT DISCLOSURE

### Field of the Present Disclosure

The present disclosure relates to a powernet domain controller controlling an output of high-voltage load and low-voltage load to reduce power consumption, and a vehicle including the same.

### Description of Related Art

A vehicle refers to a machine that transports people or cargo by driving on the road or rail.

A vehicle includes a variety of electronic devices for protecting occupants and providing the occupants with convenience and entertainment, a battery supplying power to the electronic devices, and a power generator generating power supplying the generated power to the electronic devices and battery.

The electronic devices of a vehicle may be divided into high-voltage electric devices that requires high voltage such as an electric steering device, electric compressor, and HVAC heater, and low-voltage electric devices that requires low voltage such as a seat heater and seat ventilation.

Some of the high-voltage electric devices are components of air conditioning device and consumes a significant amount of power for a short time period, as an output of air conditioning device increases in midsummer or midwinter, such electric devices consume more power, causing a reduction in driving distance of vehicle.

The information disclosed in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a powernet domain controller which may control to decrease an output of a high-voltage load and control to increase an output of a low-voltage load among a plurality of loads while a power saving mode is in operation, and a vehicle including the same.

Another aspect of the present disclosure provides the powernet domain controller which may display a display temperature corresponding to a target internal temperature while a power saving mode is in operation, and the vehicle including the same.

Additional aspects of the present disclosure will be set forth in part in the description which follows, and in part, will be obvious from the description, or may be learned by practice of the present disclosure.

According to an aspect of the present disclosure, there is provided a powernet domain controller including: a communicator configured to communicate with a battery management system managing a state of charge (SOC) value of a battery; a processor electrically connected to the communicator and configured for determining whether to activate a power saving mode based on the SoC value received through the communicator, and when the power saving mode is activated, control an output of a high-voltage load to decrease and control an output of a low-voltage load to increase.

The high-voltage load is a load to which a voltage greater than or equal to a first voltage is applied, the low-voltage load is a load to which a voltage less than or equal to a second voltage is applied, and the second voltage is less than the first voltage.

According to an aspect of the present disclosure, the communicator is configured to communicate with an inputter receiving a user input. According to an aspect of the present disclosure, the processor is configured to: identify a target internal temperature received through the inputter, identify an operation rate of the high-voltage load corresponding to the identified target internal temperature, control the high-voltage load to operate at an operation rate lower than the identified operation rate of the high-voltage load, identify a target level of the low-voltage load received through the inputter, and control the low-voltage load to operate at an operation rate higher than the identified target level.

According to an aspect of the present disclosure, the powernet domain controller further includes a memory configured to store information related to a control temperature corresponding to each of target internal temperatures. According to an aspect of the present disclosure, the communicator is configured to communicate with an inputter and an internal temperature sensor. According to an aspect of the present disclosure, in the power saving mode, the processor is configured to: identify a control temperature corresponding to a target internal temperature received through the inputter based on information stored in the memory, obtain an operation rate of the high-voltage load based on the identified control temperature and an internal temperature detected by the internal temperature sensor, and control the high-voltage load based on the obtained operation rate.

According to an aspect of the present disclosure, the processor is configured to identify a target level of the low-voltage load received through the inputter, and control the low-voltage load to operate at an operation rate higher than the identified target level.

According to an aspect of the present disclosure, the memory is configured to further store information related to a display temperature corresponding to each of control temperatures. According to an aspect of the present disclosure, the communicator is configured to communicate with a display. According to an aspect of the present disclosure, the processor is configured to identify a display temperature corresponding to the identified control temperature based on the information stored in the memory, and transmit a display command for the identified display temperature to the display.

According to an aspect of the present disclosure, the communicator is configured to communicate with an inputter receiving a user input. According to an aspect of the present disclosure, the processor is configured to control to enter the power saving mode, based on the SoC value being less than or equal to a first reference SOC value, an eco mode being received through the inputter, a heating mode being received through the inputter, and a target internal temperature received through the inputter being greater than or equal to a first reference internal temperature.

According to an aspect of the present disclosure, the communicator is configured to communicate with an inputter receiving a user input. According to an aspect of the present disclosure, the processor is configured to control to enter the power saving mode, based on the SoC value being less than or equal to a first reference SOC value, an economical mode (eco mode) being received through the inputter, a cooling mode being received through the inputter, and a target internal temperature received through the inputter being less than or equal to a second reference internal temperature.

According to an aspect of the present disclosure, the processor is configured to: in the power saving mode, control the output of the high-voltage load to decrease, and control the output of the low-voltage load to increase during a first time period, and based on the first time period having elapsed, control the output of the high-voltage load and the output of the low-voltage load to be returned during a second time period.

According to another aspect of the present disclosure, there is provided a vehicle including: a first load configured to be applied with a first voltage; a second load configured to be applied with a second voltage lower than the first voltage; a temperature controller configured to control an operation of the first load and the second load; an inputter configured to receive a user input; a battery management system configured to manage an SOC value of a battery; and a powernet domain controller configured for determining whether to activate a power saving mode is based on the SoC value, and when the power saving mode is activated, transmit an output reduction command of the first load and an output increase command of the second load to the temperature controller.

According to another aspect of the present disclosure, the first load includes a compressor and a heater of an air conditioner. The second load includes at least one of a first heating wire provided in a steering wheel, a second heating wire provided in at least one seat, or a seat ventilation provided in the at least one seat.

According to another aspect of the present disclosure, the temperature controller is configured to control the air conditioner to adjust an internal temperature, control the first heating wire to adjust a temperature of the steering wheel, and control the second heating wire or the seat ventilation to adjust a temperature of the at least one seat.

According to another aspect of the present disclosure, the powernet domain controller is configured to: identify a target internal temperature received through the inputter, identify an operation rate of the first load corresponding to the identified target internal temperature, transmit an operation rate lower than the identified operation rate of the first load as output control information of the first load to the temperature controller, identify a target level of the second load received through the inputter, and transmit a level higher than the identified target level as output control information of the second load to the temperature controller.

According to another aspect of the present disclosure, the vehicle may further include an internal temperature sensor configured to detect an internal temperature; and a memory configured to store information related to a control temperature corresponding to each of target internal temperatures. According to another aspect of the present disclosure, in the power saving mode, the powernet domain controller is configured to: identify a control temperature corresponding to a target internal temperature received through the inputter based on the information stored in the memory, obtain an operation rate of a first load based on the identified control temperature and the internal temperature detected by the internal temperature sensor, and transmit the obtained operation rate as output control information to the temperature controller.

According to another aspect of the present disclosure, the powernet domain controller is configured to identify a target level of a second load received through the inputter, and transmit a level higher than the identified target level as output control information of the second load to the temperature controller.

According to another aspect of the present disclosure, the vehicle further includes a display. According to another aspect of the present disclosure, the memory is configured to further store information related to a display temperature corresponding to each of control temperatures. According to another aspect of the present disclosure, the powernet domain controller is configured to identify a display temperature corresponding to the identified control temperature based on the information stored in the memory, and control the display to display the identified display temperature.

According to another aspect of the present disclosure, the vehicle further includes a drive motor configured to be connected to a wheel and be supplied with power from the battery. According to another aspect of the present disclosure, the powernet domain controller is configured for determining whether the vehicle is in an EV ready-on state or an EV ready-off state based on a state of the drive motor. According to another aspect of the present disclosure, in a heating mode, the powernet domain controller is configured to control to enter the power saving mode, based on the SoC value being less than or equal to a first reference SOC value, an eco mode being received through the inputter, the EV ready-on state being in operation, and a target internal temperature received through the inputter being greater than or equal to a first reference internal temperature.

According to another aspect of the present disclosure, in a cooling mode, the powernet domain controller is configured to control to enter the power saving mode, based on the SoC value being less than or equal to the first reference SOC value, the eco mode being received through the inputter, the EV ready-on state being in operation, and the target internal temperature received through the inputter being less than or equal to a second reference internal temperature.

According to another aspect of the present disclosure, in the power saving mode, the powernet domain controller is configured to turn off the power saving mode, based on the SoC value being greater than or equal to a second reference SOC value, a normal mode or a sports mode being received through the inputter, the EV ready-off state being in operation, the target internal temperature received through the inputter being greater than the second reference internal temperature, or the target internal temperature received through the inputter being less than the first reference internal temperature.

According to another aspect of the present disclosure, in the power saving mode, the powernet domain controller is configured to transmit an output reduction command of the first load and an output increase command of the second load to the temperature controller during a first time period, and based on the first time period including elapsed, transmit an output return command of the first load and an output return command of the second load to the temperature controller during a second time period.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an example of an interior of a vehicle according to an exemplary embodiment of the present disclosure;

FIG. 2 is a control block diagram illustrating a configuration of a vehicle according to an exemplary embodiment of the present disclosure;

FIG. 3 is a block diagram illustrating an example of a configuration of a battery provided in a vehicle according to an exemplary embodiment of the present disclosure;

FIG. 4 is a block diagram illustrating an example of a changed configuration of battery provided in a vehicle according to an exemplary embodiment of the present disclosure;

FIG. 5 is a diagram illustrating an example of a battery charging state for entering a power saving mode in a vehicle according to an exemplary embodiment of the present disclosure;

FIG. 6 is a table illustrating an example of a display temperature and a control temperature of a vehicle according to an exemplary embodiment of the present disclosure;

FIG. 7 is a block diagram illustrating a configuration of a powernet domain controller provided in a vehicle according to an exemplary embodiment of the present disclosure;

FIG. 8 is a graph illustrating outputs of a first load and a second load provided in a vehicle according to an exemplary embodiment of the present disclosure;

FIG. 9 is a graph illustrating output controls of the first load and the second load during a first period in the graph of FIG. 8;

FIG. 10 is a graph illustrating power consumption of a vehicle according to an exemplary embodiment of the present disclosure; and

FIG. 11 is a flowchart illustrating a control method of a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals throughout the specification denote like elements. Also, the present specification does not describe all the elements according to various exemplary embodiments of the present disclosure, and descriptions well-known in the art to which the present disclosure pertains or overlapped portions are omitted. The terms such as “—part”, “—member”, “—module”, “—device”, and the like may refer to at least one process processed by at least one hardware or software. According to various exemplary embodiments of the present disclosure, a plurality of “—parts”, “—members”, “—modules”, “—devices” may be embodied as a single element, or a single of a “part”, “—member”, “—module”, “—device” may include a plurality of elements.

It will be understood that when an element is referred to as being “connected” to another element, it may be directly or indirectly connected to the other element, wherein the indirect connection includes “connection” via a wireless communication network.

It will be understood that the term “include” when used in the present specification, specifies the presence of stated features, integers, steps, operations, elements, and/or components, but does not preclude the presence or addition of at least one other features, integers, steps, operations, elements, components, and/or groups thereof.

It will be understood that, although the terms first, second, etc. may be used herein to describe various elements, these elements should not be limited by these terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

Hereinafter, an operation principle and embodiments will be described in detail with reference to the accompanying drawings.

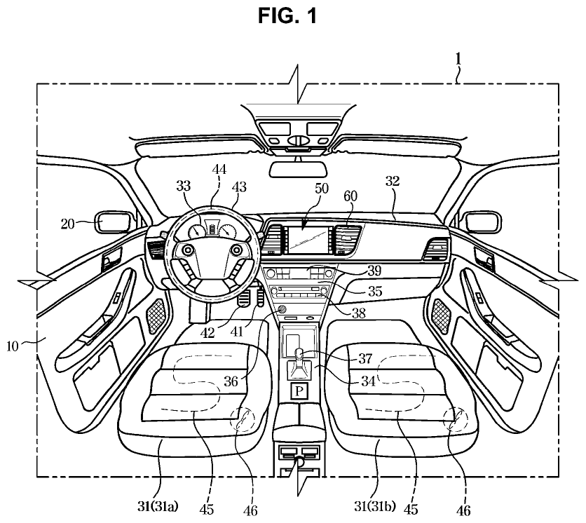

FIG. 1 is a diagram illustrating an example of an interior of a vehicle according to an exemplary embodiment of the present disclosure.

A vehicle according to the exemplary embodiment of the present disclosure may be a green vehicle driven by electricity to reduce fuel consumption and emission of harmful gases.

A green vehicle includes an electric vehicle including a rechargeable battery and a drive motor, rotating the drive motor with electricity accumulated in the battery, and driving wheels using the rotation of the motor, and a hybrid vehicle, and a hydrogen fuel cell vehicle including an engine, a battery, and a motor and driven by controlling mechanical power of the engine and electric power of the motor.

An electric vehicle is referred to as an example in the exemplary embodiment of the present disclosure.

A vehicle 1 includes a body including an exterior and an interior, and a chassis where mechanical devices for driving are provided as a remaining portion except for the body.

The exterior of the vehicle body includes a front panel, a bonnet, a roof panel, a rear panel, a plurality of doors 10, and window glass provided to each of the doors 10 to be able to be opened and closed.

The exterior of the vehicle body includes side mirrors 20 providing a driver with a rear view of the vehicle 1, and a lamp or lamps allowing the driver to easily see surrounding information while keeping an eye toward the front of the vehicle 1 and the road. The lamp or lamps also function as a signal or communication method with respect to another vehicle and pedestrians.

As shown in FIG. 1, the interior of the vehicle body includes a seat 31 (31a and 31b) provided for an occupant to sit on, a dashboard 32, a cluster 33, a center fascia 34 on which an air vent of air conditioner, a control panel, etc., are disposed, a head unit 35, and a start button (also referred to as a booting button, 36). Here, the cluster 33 is provided on the dashboard 32 and includes a tachometer, speedometer, coolant thermometer, fuel gauge, turn indicator, high beam indicator, warning light, seat belt warning light, odometer, shift lever indicator, door open warning light, engine oil warning light, low oil warning light, etc. The head unit 35 is provided on the center fascia 34 and receives an operation command for an electric component such as an audio device and the air conditioner, and the start button 36 provided on the center fascia 34 receives an input of a start command.

The cluster 33 may include a display panel, and display information related to a battery charging state, a driving mode, and a power saving mode in response to a control command of a powernet domain controller (PDC) 100.

The vehicle 1 further includes a shift lever 37 provided in the center fascia 34 and receiving an operation position, and a parking button (electronic parking brake (EPB) button) disposed around the shift lever 37 or on the head unit 35 and receiving an operation command of an EPB.

The head unit 35 may include an inputter 38 receiving a command from a user and a display 39 displaying various information of the vehicle 1.

The inputter 38 may include a hardware device such as various buttons or switches, a pedal, a keyboard, a mouse, a track-ball, various levers, a handle, a stick, and the like.

The head unit 35 may also include a graphical user interface (GUI) such as a touch pad, i.e., a software device. The touch pad may be implemented as a touch screen panel (TSP) and form a mutual layer structure with a display, or provided independently from the head unit 35.

The head unit 35 may be connected to a plurality of controllers, and transmit an ON/OFF command received through the inputter 38 and operation information to at least one controller. Here, the at least one controller may be a controller configured for controlling electronic devices of the vehicle.

The vehicle 1 includes an accelerator pedal 41 depressed by the user according to a user's acceleration intention, a brake pedal 42 depressed by the user according to a user's braking intention, and a steering wheel 43 of a steering device for adjusting a driving direction.

The vehicle 1 may include a variety of electronic devices for control of the vehicle 1 and occupants' safety and convenience. The electronic devices may communicate to each other through a vehicle communication network (NT). For example, the electronic devices may transmit and receive data through Ethernet, Media Oriented Systems Transport (MOST), a FlexRay, Controller Area Network (CAN), Local Interconnect Network (LIN), and the like.

For example, the electronic devices may include an audio, video, navigation (AVN) device or a vehicle terminal 50 providing the user with various information and entertainment, a heating/ventilation/air conditioning (HVAC, 60) controlling an inflow of air from an outside of the vehicle 1 or heats or cools indoor air according to a target internal temperature, a door lock device, a windscreen wiper, a steering wheel heater (a first heating wire, 44) provided on the steering wheel 43, a power seat for adjusting an angle or position of each seat, a seat heater (a second heating wire, 45) provided in each seat, a seat ventilation 46 provided in each seat, indoor lamps and a power tailgate.

The second heating wire 45 may be provided on the driver's seat 31a. The second heating wire 45 may also be provided on each of the driver's seat 31a and a passenger seat 31b. The second heating wire 45 may also be provided on each of seats in the vehicle 1.

The seat ventilation 46 may be provided on the driver's seat 31a. The seat ventilation 46 may also be provided on each of the driver's seat 31a and the passenger seat 31b. The seat ventilation 46 may also be provided on each of the seats in the vehicle 1.

The seat ventilation 46 may be provided inside the seat 31, and include a circulation fan for circulating air.

The HVAC 60 may include a heating, ventilation, and air conditioning (HVAC) heater (or radiator) generating heat, a heating, ventilation, and air conditioning (HVAC) compressor that compresses refrigerant, and a blowing fan that blows heat-exchanged air.

The above electronic devices may be loads receiving power from a battery and consuming the received power while performing predetermined functions.

The loads may be divided into a high-voltage load using a voltage greater than or equal to a first preset voltage, and a low-voltage load using a voltage less than a second preset voltage.

Here, the first preset voltage may be approximately 400V, or approximately 800V, and the second preset voltage may be approximately 12V.

For example, the high-voltage load may include the HVAC compressor and HVAC heater provided in the HVAC 60, a battery heater provided in a battery, and the like. The low-voltage load may include the first heating wire 44, the second heating wire 45, the seat ventilation 46, the blowing fan provided in the HVAC 60, the circulation fan provided in the seat ventilation 46, etc.

The chassis of the vehicle 1 may include a plurality of wheels of the vehicle 1, a power device for applying a driving force to the wheels of the vehicle 1, a steering device, a brake device for applying a braking force to the wheels of the vehicle 1, and a suspension device for adjusting a suspension of the vehicle 1.

The steering device may employ a motor driven power steering (MDPS) method that utilizes a rotation force of a steering motor, and include an electronic control device controlling the steering motor.

The power device is a device configured for generating a driving force required for driving and adjusting the generated driving force.

The power device may include a battery, a drive motor, an inverter, a speed reducer, and a charging controller. Here, the battery may be a high voltage battery.

The battery may include a plurality of battery cells configured for generating high-voltage current to supplying a driving force to the vehicle.

The drive motor generates rotation force using electrical energy of the battery and transmits the generated rotation force to the wheels, allowing the wheels to be driven.

When the start button 36 is turned on, a maximum current is supplied to the drive motor, generating maximum torque.

The drive motor may be operated as a generator to charge the battery under energy regeneration conditions such as braking, deceleration, downhill driving or low speed driving.

An inverter may convert power of the battery into driving power of the drive motor.

When outputting the driving power of the drive motor, the inverter outputs the driving power of the drive motor based on a target driving speed according to a user command. Here, the driving power of the drive motor may vary depending on a switching signal for outputting a current corresponding to the target driving speed and a switching signal for outputting a voltage corresponding to the target driving speed.

The inverter may also transfer power generated from the drive motor to a first battery during regenerative braking. That is, the inverter may include a plurality of switch devices and perform a function of changing an output and direction of current between the drive motor and the battery.

The speed reducer reduces a speed of the drive motor, and transfers a rotation force increasing the torque of the drive motor to the wheels.

The vehicle 1 may further include a charging controller which is connected to a fast charging cable or a slow charging cable and receives power for charging the battery.

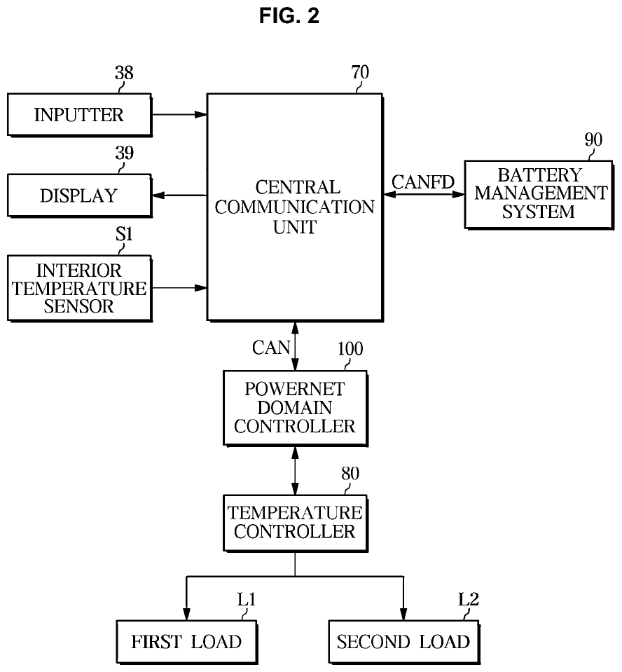

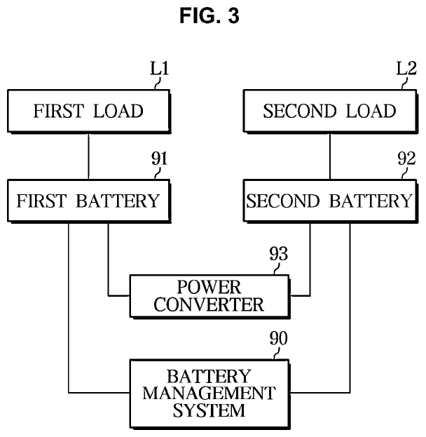

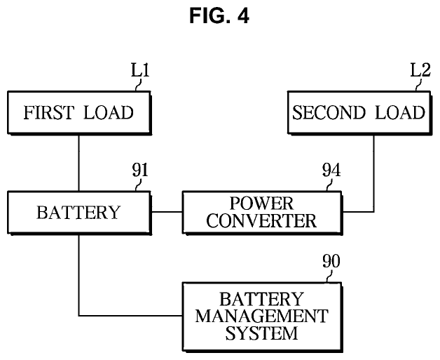

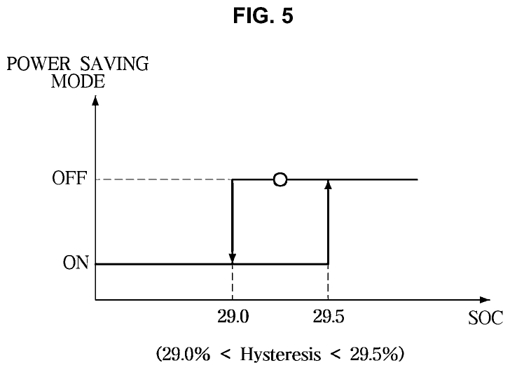

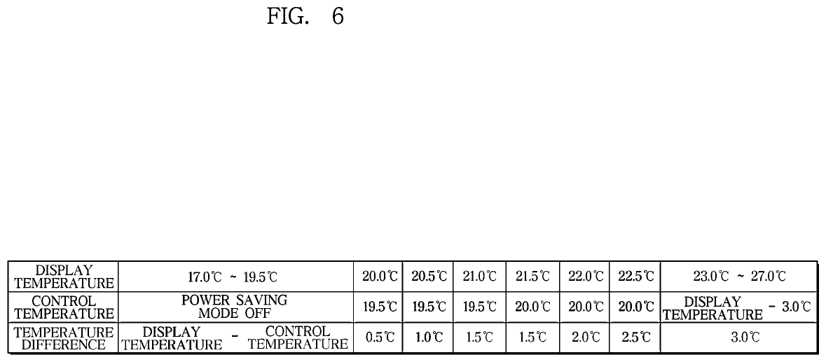

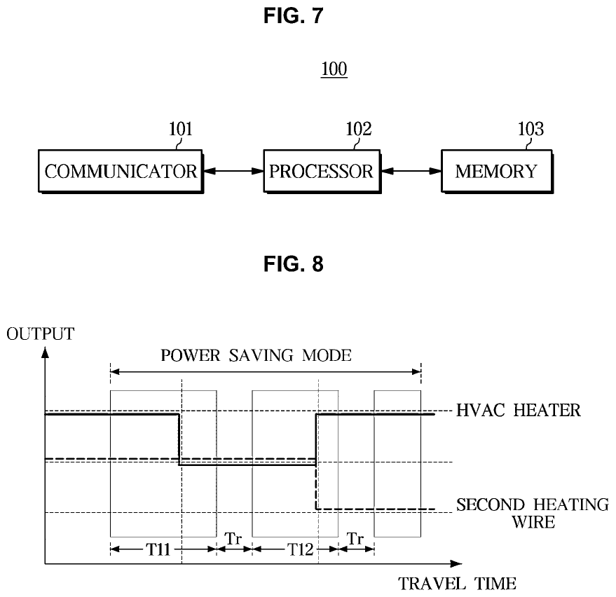

FIG. 2 is a control block diagram illustrating a configuration of a vehicle according to an exemplary embodiment of the present disclosure. FIG. 3 is a block diagram illustrating an example of a configuration of a battery provided in a vehicle according to an exemplary embodiment of the present disclosure. FIG. 4 is a block diagram illustrating an example of a changed configuration of battery provided in a vehicle according to an exemplary embodiment of the present disclosure. FIG. 5 is a diagram illustrating an example of a battery charging state for entering a power saving mode in a vehicle according to an exemplary embodiment of the present disclosure. FIG. 6 is a table illustrating an example of a display temperature and a control temperature of a vehicle according to an exemplary embodiment of the present disclosure. FIG. 7 is a block diagram illustrating a configuration of a powernet domain controller provided in a vehicle according to an exemplary embodiment of the present disclosure.

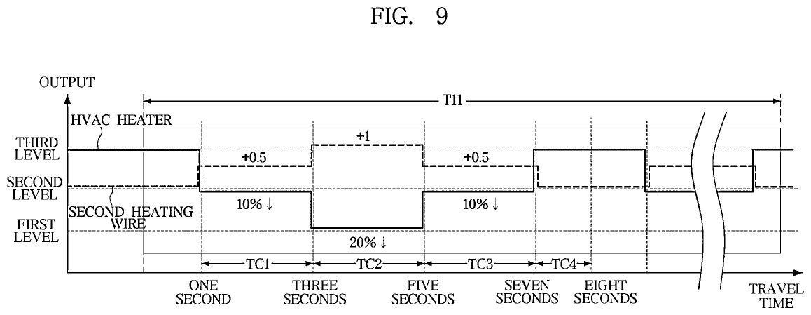

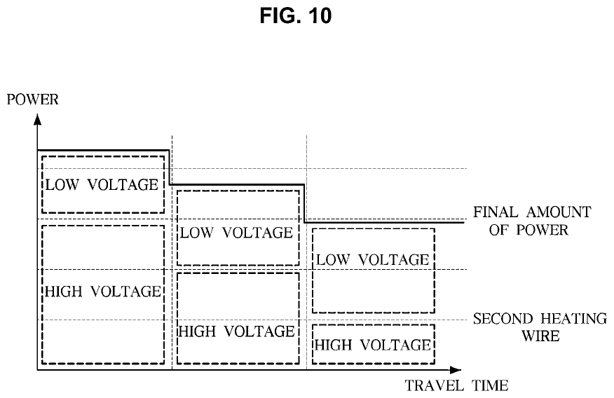

FIG. 8 is a graph illustrating outputs of a first load and a second load provided in a vehicle according to an exemplary embodiment of the present disclosure. FIG. 9 is a graph illustrating output controls of the first load and the second load during a first period in the graph of FIG. 8. FIG. 10 is a graph illustrating power consumption of a vehicle according to an exemplary embodiment of the present disclosure.

The vehicle 1 includes a first load L1, a second load L2, an inputter 38, a display 39, a central communication unit (CCU, 70), a temperature controller 80, a battery management system 90 and a powernet domain controller (PDC) 100.

The first load L1 may be a high-voltage load applied with a voltage, which is greater than or equal to a first preset voltage, and perform an operation using the applied voltage. For example, the high-voltage load may include a compressor or a heater of the HVAC 60.

The high-voltage load may be a load applied with approximately 400V or approximately 800V.

The second load L2 may be a low-voltage load applied with a voltage, which is less than a second preset voltage, and perform an operation using the applied voltage.

The low-voltage load may be a load applied with approximately 12V.

The second load L2 may be applied with a voltage lower than the voltage applied with the first load L1. For example, the second load L2 may include the first heating wire 44, the second heating wire 45, and the circulation fan of the seat ventilation 46.

An internal temperature sensor S1 may be provided inside the vehicle 1, detect an internal temperature of the vehicle 1, and transmit internal temperature information related to the detected internal temperature to the temperature controller 80.

The inputter 38 receives a user input.

The inputter 38 may receive a booting-on command, a booting-off command, and a shift command of the vehicle, and receive an ON/OFF command and operation information of at least one of a plurality of electronic devices provided in the vehicle.

The ON/OFF command of the at least one of the electronic devices may include a cooling ON/OFF command, a heating ON/OFF command, an ON/OFF command for the first heating wire 44, an ON/OFF command for the second heating wire 45, or an ON/OFF command for the seat ventilation 46, etc.

The operation information of the at least one of the electronic devices may include target internal temperature information, air volume information, wind direction information, target level information of the first heating wire 44, target level information of the second heating wire 45, or target level information of the seat ventilation 46, and the like.

The target level information of the first heating wire 44 is information related to a target temperature of the first heating wire 44, and may include a first level and a second level. The target level information of the second heating wire 45 is information related to a target temperature of the second heating wire 45, and may include a first level, a second level and a third level.

The target level information of the seat ventilation 46 is information related to a target air volume of the seat ventilation, and may include a first level and a second level.

The inputter 38 may receive at least one driving mode of a normal mode, sports mode, or eco mode.

In the normal mode, an output of a drive motor is controlled so that the vehicle travels at a driving speed corresponding to the amount of pressure when the accelerator pedal 41 is pressed.

The eco mode may allow the vehicle to drive in a maximized fuel efficiency when driving in a city or on a highway. In the eco mode, fuel consumption caused by unnecessary acceleration may be prevented by limiting an output of the drive motor, without increasing a speed of the drive motor corresponding to the amount of pressure when the accelerator pedal 41 is pressed.

The sports mode may allow high RPM to be maintained even when the accelerator pedal 41 is not pressed. In the sports mode, although fuel efficiency may be reduced, sensitivity to accelerator pedal pressure is high and active driving may be enabled.

The inputter 38 may be provided in the vehicle terminal 50, or provided on the head unit 35 or the center fascia 34, or around the steering wheel 43.

The display 39 may display ON/OFF information, operation information, etc., of electronic device in operation, and display a user input input to the inputter 38.

For example, the display 39 may display ON/OFF information of a cooling mode, ON/OFF information of a heating mode, an actual internal temperature and a target internal temperature of the vehicle, and air volume and wind direction of HVAC. Also, the display 39 may display at least one of ON/OFF information and a target level of the first heating wire 44, ON/OFF information and a target level of the second heating wire 45, or ON/OFF information and air volume information of the seat ventilation 46.

The display 39 may display the actual internal temperature of the vehicle and a target internal temperature selected by the user. Here, the actual internal temperature may be a temperature detected by the internal temperature sensor S1.

The display 39 may display an actual outdoor temperature of the vehicle. Here, the actual outdoor temperature may be a temperature detected by an outdoor temperature sensor.

The display 39 may display a display temperature in response to a control command of the PDC 100 in a power saving mode. Here, the display temperature may be different from the temperature detected by the internal temperature sensor S1, and be different from the target internal temperature selected by the user.

The display 39 may display a driving mode, a possible driving distance, and battery charging amount.

The display 39 may be provided in the vehicle terminal 50, or on the head unit 35 or the center fascia 34 of the vehicle 1.

The display 39 may be provided in the cluster 33.

The central communication unit (CCU, 70) may include at least one constituent component facilitating communication between an external device or the constituent components of the vehicle, for example, at least one of a short-range communication module, wireless communication module, or a wired communication module. Here, the external device may include a server, a remote controller, and a user terminal.

The short-range communication module may include a variety of short-range communication modules that transmit and receive signals in a short distance using a wireless communication network, such as a Bluetooth module, infrared communication module, radio frequency identification (RFID) communication module, wireless local access network (WLAN) communication module, near-field communication (NFC) communication module, Zigbee communication module, and the like.

The wired communication module may include various wired communication modules such as a Controller Area Network (CAN) communication module, local area network (LAN) module, wide area network (WAN) module, value added network (VAN) module, or the like, and also include various cable communication modules such as a universal serial bus (USB), high definition multimedia interface (HDMI), digital visual interface (DVI), recommended standard 232 (RS-232), power line communication, plain old telephone service (POTS), or the like.

The wired communication module may further include a Local Interconnect Network (LIN).

The wireless communication module may include wireless communication modules that support a variety of wireless communication methods such as a Global System for Mobile communication (GSM), Code Division Multiple Access (CDMA), wideband CDMA (WCDMA), Universal Mobile Telecommunications System (UMTS), Time Division Multiple Access (TDMA), Long Term Evolution (LTE), ultra wideband (UWB), and the like, in addition to a Wifi module and a Wibro module.

The temperature controller 80 may be an electronic control unit (ECU) controlling an operation of at least one of the first load L1 or the second load L2 based on the ON/OFF command and operation information received by the inputter 38.

The temperature controller 80 may control an operation of at least one of the first load L1 or the second load L2, controlling an internal temperature of the vehicle or a temperature of an object contacting with the user. Here, the object contacting with the user may include the seat 31 and the steering wheel 43.

When the first load L1 is a compressor, based on the cooling mode and target internal temperature information being received, the temperature controller 80 may control the compressor of the HVAC 60 until an actual internal temperature reaches a target internal temperature. In the present instance, the temperature controller 80 may control an operation rate of the compressor.

Here, the operation rate of the compressor may be a target output amount of the compressor. The target output amount may be expressed as a ratio (%).

When the first load L1 is a compressor of the HVAC 60 (i.e. An HVAC compressor), the temperature controller 80 may control the amount of power supplied to the compressor based on an operation rate of the compressor. Controlling the amount of power supplied to the compressor may include controlling a voltage or current applied to the compressor.

When the first load L1 is a heater of the HVAC 60 (i.e. An HVAC heater), based on the heating mode and target internal temperature information being received, the temperature controller 80 may control the HVAC heater until an actual internal temperature reaches the target internal temperature. In the present instance, the temperature controller 80 may control an operation rate of the HVAC heater. Here, the operation rate of the HVAC heater may be an output amount of the HVAC heater.

When the first load L1 is the HVAC heater, the temperature controller 80 may also control the amount of power supplied to the HVAC heater based on the operation rate of the HVAC heater.

Controlling the amount of power supplied to the HVAC heater may include controlling a voltage or current applied to the HVAC heater.

When the second load L2 is the first heating wire 44, the temperature controller 80 may control a voltage or current applied to the first heating wire 44 based on target level information input through the inputter 38.

When the second load L2 is the second heating wire 45, the temperature controller 80 may control a voltage or current applied to the second heating wire 45 based on target level information input through the inputter 38.

The temperature controller 80 may control at least one of the first load L1 or the second load L2 based on output control information of the first load L1 received from the PDC 100. Here, the output control information may be temperature control information.

The temperature controller 80 may control the output of the first load L1 based on the output control information of the PDC 100. Here, the output control information may include the amount of reduction in output, a first time corresponding to a period, and a second time between periods. The amount of reduction in output may include a first reduction amount and a second reduction amount.

Controlling the output of the first load L1 may include controlling the amount of heat absorption or the amount of heat generation by the first load L1.

To control the output of the first load L1, the temperature controller 80 may control the amount of power supplied to the first load L1.

The temperature controller 80 may control the output of the second load L2 based on the output control information of the second load L2 received from the PDC 100.

Here, the output control information may include the amount of increase in output, a first time corresponding to a period, and a second time between periods. The amount of increase in output may include a first increase amount and a second increase amount.

Controlling the output of the second load L2 may include controlling the amount of heat generation of the second load L2.

To control the output of the second load L2, the temperature controller 80 may control the amount of power supplied to the second load L2.

The temperature controller 80 may be a body domain controller (BDM) for controlling the HVAC, a door lock device, a windscreen wiper, a power seat, the first heating wire, the second heating wire, the seat ventilation, indoor lamps and a power tailgate.

The temperature controller 80 may transmit control information of the first load L1 to the PDC 100, and transmit control information of the second load L2 to the PDC 100.

The temperature controller 80 may transmit an internal temperature of the vehicle detected by the internal temperature sensor S1 to the PDC 100

The temperature controller 80 may transmit information related to power consumption of the first load L1 and power consumption of the second load L2 to the PDC 100.

The battery management system (BMS, 90) may obtain state information related to a battery.

The BMS 90 may include a plurality of sensors collecting the state information such as battery output voltage, battery input/output current, battery temperature, and the like.

The plurality of sensors may include a plurality of current sensors for detecting a respective current of battery, a plurality of voltage sensors for detecting a respective voltage of an output terminal of battery, and temperature sensors for detecting a respective temperature of battery.

The BMS 90 may monitor information related to a voltage, current and power of battery, and transmit the monitored information to the PDC 100.

Also, the BMS 90 may be configured to determine and manage a state of charge (SoC) and a state of health (SoH) of battery based on the state information of battery.

The BMS 90 may monitor a battery charging state, and transmit state information related to the battery charging state to the PDC 100.

The BMS 90 may obtain the battery charging state corresponding to a current, voltage and temperature of each battery cell from a pre-stored table. The battery charging amount corresponding to each correlation among currents, voltages and temperatures of battery cells may be matched and stored in the pre-stored table.

As shown in FIG. 3, the vehicle may include a first battery 91, a second battery 92 and a power converter 93.

The first battery 91 may be charged or discharged. The first battery 91 may be charged by receiving external power, or by use of power generated during regenerative braking.

The first battery 91 may supply power to a powertrain apparatus including a drive motor, etc., and to the first load L1 consuming high power. The first battery 91 may be a high voltage battery.

The first battery 91 may supply power to the second battery 92. In the instant case, the vehicle may charge the second battery 92 using the power converter 93.

The power converter 93 converts DC power of the first battery 91 into DC power suitable for charging the second battery 92, and supplies the converted DC power to the second battery 92, allowing the second battery 92 to be charged.

The power converter 93 may include at least one switch element and an inductor. The power converter 93 may be controlled by the PDC 100.

The second battery 92 may be charged or discharged.

The second battery 92 may be charged by use of power charged in the first battery 91.

The second battery 92 may be a low voltage battery.

The second battery 92 supplies power to loads such as convenience devices and additional devices. Here, the load receiving power from the second battery 92 is the second load L2 and may include the first heating wire 44, the second heating wire 45, and the seat ventilation 46.

The second battery 92 may supply power to the second load L2 regardless of booting-on or booting-off.

The BMS 90 may perform monitoring on the first battery 91 and the second battery 92. The BMS 90 may monitor information related to a voltage, current, and power of the first battery 91 and the second battery 92, and transmit the monitored information to the PDC 100.

The BMS 90 may transmit information related to a charging amount of the first battery 91 and the second battery 92 to the PDC 100. The charging amount of the first battery 91 and the second battery 92 may be a state of charge (SOC) value of the first battery 91 and the second battery 92.

As shown in FIG. 4, the vehicle may include the battery 91 and the power converter 94.

The battery 91 may be the same as the first battery illustrated in FIG. 3.

The battery 91 may be charged or discharged.

The battery 91 may be charged by receiving external power, or by use of power generated during regenerative braking.

The battery 91 may supply power to a powertrain apparatus including a drive motor, etc., and the first load L1 consuming high power. The battery 91 may be a high voltage battery.

The battery 91 may supply power to the second load L2 through the power converter 94.

The power converter 94 may convert DC power of the battery 91 into DC power required for operating the second load L2, and supply the converted DC power to the second load L2.

The power converter 94 may include at least one switch element and an inductor. The power converter 94 may be controlled by the PDC 100.

The second load L2 is a load like convenience devices and additional devices, and may include the first heating wire 44, the second heating wire 45 and the seat ventilation 46.

The BMS 90 may perform monitoring on the battery 91. The BMS 90 may monitor information related to a voltage, current, and power of the battery 91, and transmit the monitored information to the PDC 100.

The BMS 90 may transmit information related to a charging amount of the battery 91 to the PDC 100. The charging amount of the battery 91 may be a state of charge (SOC) value of the battery 91.

The PDC 100 may monitor a power state of the entire vehicle, and manage power supplied to the first load L1 and the second load L2 based on the monitored power state.

A vehicle's PDC including a configuration of the battery shown in FIG. 3 is described as an example.

The power state of the entire vehicle may be a state that utilizes power charged in the first battery 91.

The PDC 100 is configured to determine whether switching to a power saving mode is required based on the monitored total amount of power.

The power saving mode is for minimizing power consumption of the first battery 91 according to a user input or an internal control logic of the PDC. The power saving mode may be selectively activated according to user needs. For example, the power saving mode may be activated when a user selects the power saving mode through the inputter 38.

The PDC 100 may be configured to determine whether the vehicle is in an electric vehicle (EV) ready-on state or EV ready-off state, based on an operation state of a drive motor and a pressure state of an accelerator pedal.

The EV ready-on state may be a state where power is applied to the drive motor, and the EV ready-off state may be a state where power is not applied to the drive motor. Also, the EV ready-off state may be a state where power is not applied to the drive motor even when the accelerator pedal is depressed.

The PDC 100 may also automatically determine the power saving mode, based on a charging state of the first battery 91, a driving mode selected by the user, the EV ready-ON/OFF state, a cooling ON/OFF state, a heating ON/OFF state, target internal temperature information and outdoor temperature information of the vehicle.

The PDC 100 may maintain existing control on the first load L1 and the second load L2, when it is determined that switching to the power saving mode is not required.

The PDC 100 may control an output of the first load L1 and the second load L2, when it is determined that switching to the power saving mode is required.

When the power saving mode is in operation, the PDC 100 may decrease the output of the first load L1, and increase the output of the second load L2, improving a user's satisfaction in sensory temperature and reducing the entire power consumption of the vehicle.

Decreasing the output of the first load L1 includes increasing an internal temperature of the vehicle compared to a target internal temperature in a cooling mode, and decreasing an internal temperature of the vehicle compared to a target internal temperature in a heating mode.

Decreasing the output of the first load L1 includes decreasing an output of a compressor in the cooling mode, and decreasing an output of a heating, ventilation, and air conditioning (HVAC) heater in the heating mode.

Increasing the output of the second load L2 includes increasing an output of a seat ventilation in the cooling mode, and increasing an output of at least one of a first heating wire or a second heating wire in the heating mode.

The cooling mode is a mode for decreasing an indoor temperature of the vehicle, and may include a cooling mode of the HVAC 60 and an ON operation of the seat ventilation 46.

The heating mode is a mode for increasing an indoor temperature of the vehicle, and may include a heating mode of the HVAC 60 and an ON operation of the first heating wire 44 and the second heating wire 45.

The PDC 100 for performing the power saving mode is described in greater detail below.

The PDC 100 identifies the charging state of the first battery 91, the driving mode selected by the user, the EV ready-ON/OFF state, the cooling ON/OFF state, the heating ON/OFF state, the target internal temperature information and the outdoor temperature information.

The PDC 100 may be configured to determine whether an outdoor temperature detected by an outdoor temperature sensor is less than or equal to a first reference outdoor temperature, and when it is determined that the outdoor temperature detected by the outdoor temperature sensor is less than or equal to the first reference outdoor temperature, automatically control an ON operation of the heating mode. For example, the first reference outdoor temperature may be approximately 7 degrees Celsius.

The PDC 100 may be configured to determine whether an outdoor temperature detected by the outdoor temperature sensor is greater than or equal to a second reference outdoor temperature, and when it is determined that the outdoor temperature detected by the outdoor temperature sensor is less than or equal to the second reference outdoor temperature, automatically control an ON operation of the cooling mode. For example, the second reference outdoor temperature may be an outdoor temperature in summer.

When it is determined that the heating mode is in an ON state and a driving mode is an eco mode, the PDC 100 may enter the power saving mode.

When it is determined that the heating mode is in an ON state, a target internal temperature is greater than or equal to a first reference internal temperature, and the driving mode is the eco mode, the PDC 100 may enter the power saving mode. For example, the first reference internal temperature may be approximately 20 degrees Celsius.

When it is determined that the cooling mode is in an ON state and the driving mode is the eco mode, the PDC 100 may enter the power saving mode.

When it is determined that the cooling mode is in an ON state, the target internal temperature is less than or equal to a second reference internal temperature, and the driving mode is the eco mode, the PDC 100 may enter the power saving mode.

When an ON command for the power saving mode is received through the inputter 38, the PDC 100 may also enter the power saving mode.

The PDC 100 is configured to determine whether the charging state of the first battery 91 is less than or equal to a first reference SoC (a first reference charging state), and when it is determined that the charging state of the first battery 91 is less than or equal to the first reference SOC value, is configured to determine whether the heating mode is in an ON state. When it is determined that the heating mode is in an ON state, the PDC 100 is configured to determine whether the driving mode is the eco mode. When it is determined that the driving mode is the eco mode, the PDC 100 is configured to determine whether the target internal temperature received by the inputter is greater than or equal to the first reference internal temperature. When it is determined that the received target internal temperature is greater than or equal to the first reference internal temperature, the PDC 100 is configured to determine whether the vehicle is in the EV ready-on state. When it is determined that the vehicle is in the EV ready-on state, the PDC 100 enters the power saving mode.

The first reference SoC may be SoC 29%.

When it is determined that the charging state of the first battery 91 is less than or equal to the first reference SOC value, the driving mode is the eco mode, the heating mode is in an ON state, and the received target internal temperature is greater than or equal to the first reference internal temperature, the PDC 100 enters the power saving mode.

When it is determined that the charging state of the first battery 91 is less than or equal to the first reference SOC value, the driving mode is the eco mode, the cooling mode is in an ON state, and the received target internal temperature is less than or equal to the second reference internal temperature, the PDC 100 may also enter the power saving mode.

While the power saving mode and the heating mode are in operation, the PDC 100 is configured to determine whether the charging state of the first battery 91 is greater than a second reference SoC (a second reference charging state), is configured to determine whether the driving mode is a sports mode or a normal mode, is configured to determine whether the vehicle is in the EV ready-off state, is configured to determine whether the heating mode is in an OFF state, and is configured to determine whether the received target internal temperature is less than the first reference internal temperature. In the present instance, when it is determined that at least one condition is satisfied, the PDC 100 may deactivate the power saving mode.

Here, the second reference SoC may be SoC 29.5%.

While the power saving mode and the cooling mode are in operation, the PDC 100 is configured to determine whether the charging state of the first battery 91 is greater than the second reference SOC value, is configured to determine whether the driving mode is the sports mode or the normal mode, is configured to determine whether the vehicle is in the EV ready-off state, is configured to determine whether the cooling mode is in an OFF state, and is configured to determine whether the received target internal temperature is greater than the second reference internal temperature. In the present instance, when it is determined that at least one condition is satisfied, the PDC 100 may deactivate the power saving mode.

That is, when it is determined that the charging state of the first battery 91 is greater than the second reference SoC in the power saving mode, the PDC 100 may deactivate the power saving mode.

When it is determined that the driving mode is the sports mode or the normal mode in the power saving mode, the PDC 100 may deactivate the power saving mode.

When it is determined that the vehicle in the power saving mode is in the EV ready-off state, the PDC 100 may deactivate the power saving mode.

The EV ready-off state may be a state where power is not applied to the drive motor, and may be a state where the drive motor is not operated even when the accelerator pedal is depressed.

When it is determined that the heating mode or the cooling mode is in an OFF state while in the power saving mode, the PDC 100 may deactivate the power saving mode.

When it is determined that the received target internal temperature is less than the first reference internal temperature while the power saving mode and the heating mode are in operation, the PDC 100 may deactivate the power saving mode.

When it is determined that the received target internal temperature is greater than the second reference internal temperature while the power saving mode and the heating mode are in operation, the PDC 100 may deactivate the power saving mode.

As shown in FIG. 5, the PDC 100 may be configured to determine whether the charging state of the first battery 91 is greater than the second reference SoC in the power saving mode, and when it is determined that the charging state of the first battery 91 is greater than the second reference SOC value, deactivate the power saving mode. Also, the PDC 100 may be configured to determine whether the charging state of the first battery 91 is less than or equal to the first reference SoC in a deactivation state of the power saving mode, and when it is determined that the charging state of the first battery 91 is less than or equal to the first reference SOC value, enter the power saving mode.

Here, a state of charge (a charging state) which is greater than the first reference SOC value and less than or equal to the second reference SoC may be a hysteresis.

The PDC 100 may transmit temperature control information through the first load L1 and the second load L2 to the temperature controller 9 in the power saving mode.

In the power saving mode and the heating mode, the PDC 100 may identify the target internal temperature information received through the inputter 38, obtain control temperature information for power saving based on the obtained target internal temperature information, control an output of the HVAC heater based on the obtained control temperature information, obtain display temperature information corresponding to the obtained control temperature information, and control the display 39 to display the obtained display temperature information.

When controlling the output of the HVAC heater based on the obtained control temperature information, the PDC 100 may control an output of the HVAC heater to decrease and control an output of at least one of the first heating wire 44 or the second heating wire 45 to increase.

When controlling the output of the first heating wire 44 to increase, the PDC 100 may control the output of the first heating wire 44 to increase to a level higher than that selected by the user.

When controlling the output of the second heating wire 45 to increase, the PDC 100 may control the output of the second heating wire 45 to increase to a level higher than that selected by the user.

When controlling the outputs of the first heating wire 44 and the second heating wire 45 to increase, the PDC 100 may control the output of the first heating wire 44 to increase to a level higher than that selected by the user, and control the output of the second heating wire 45 to increase to a level higher than that selected by the user.

When controlling the output of the HVAC heater based on the obtained control temperature information, the PDC 100 may be configured to determine whether a control temperature reaches an internal temperature based on internal temperature information detected by the internal temperature sensor S1 and the obtained control temperature information, and when it is determined that the control temperature reaches the internal temperature, may stop operating the HVAC heater.

Here, a temperature controlled by the control temperature information in the heating mode may be lower than the target internal temperature.

A temperature displayed by the display temperature information is different from the temperature detected by the internal temperature sensor S1 and also different from the target internal temperature.

The temperature displayed by the display temperature information may be a temperature allowing the user to believe as the temperature detected by the internal temperature sensor S1 to reduce user dissatisfaction.

As shown in FIG. 6, the display temperature information corresponding to the control temperature information may be stored in a temperature table, and the PDC 100 may control displaying of the display temperature information based on the temperature table.

A difference between the control temperature and the display temperature may be approximately 0.5 degrees Celsius to 3 degrees Celsius, minimizing a user's discomfort.

In the power saving mode and the cooling mode, the PDC 100 may identify the target internal temperature information received through the inputter 38, obtain control temperature information for power saving based on the obtained target internal temperature information, control an output of the HVAC compressor based on the obtained control temperature information, obtain display temperature information corresponding to the obtained control temperature information, and control the display 39 to display the obtained display temperature information. Here, a temperature controlled by the control temperature information in the cooling mode may be higher than the target internal temperature.

When controlling the output of the HVAC compressor based on the obtained control temperature information, the PDC 100 may be configured to determine whether a control temperature reaches an internal temperature based on the internal temperature information detected by the internal temperature sensor S1 and the obtained control temperature information, and when it is determined that the control temperature reaches the internal temperature, may stop operating the HVAC compressor.

When controlling the output of the HVAC compressor based on the obtained control temperature information, the PDC 100 may control the output of the compressor to decrease and control the output of the seat ventilation 46 to increase. When controlling the output of the seat ventilation 46 to increase, the PDC 100 may control the output of the seat ventilation 46 to increase to a level higher than that selected by the user.

In the power saving mode, the PDC 100 may periodically control the output of the first load to decrease and return, and also periodically control the output of the second load to increase and return.

For example, in the power saving mode, the PDC 100 may control the output of the first load to decrease and control the output of the second load to increase during a first time period, and when the first time period elapses, may control the output of the first load and the output of the second load to return during a second time period.

Here, the first time period may be approximately 40 seconds, and the second time period may be approximately 4 seconds.

In the power saving mode, the PDC 100 may reduce power consumed in the first load L1, reducing the total amount of power consumed in the vehicle.

The above-described PDC 100 may be implemented as a memory 103 storing an algorithm for controlling operations of constituent components of the PDC 100 or data about a program that reproduces the algorithm, and a processor 102 performing the above-described operations using the data stored in the memory 103.

As shown in FIG. 7, the PDC 100 may include a communicator 101, the processor 102 and the memory 103.

The communicator 101 may communicate with the CCU 70.

The communicator 101 may transmit and receive information with the temperature controller 80, the inputter 38, and the display 39 through communication with the CCU 70, and transmit and receive information with the BMS 90 through communication with the CCU 70.

The communicator 101 may perform communication of a Local Interconnect Network (LIN) method, Controller Area Network (CAN) method, pulse width modulation (PWM) method, and controller area network flexible data-rate (CAN FD) method.

The processor 102 may receive information related to the total amount of power consumed in the vehicle from the BMS 90.

The processor 102 monitors the total amount of power consumed in the vehicle based on battery charging state information received from the BMS 90.

The processor 102 may control to switch to the power saving mode, based on the charging state of the first battery 91, a driving mode selected by the user, an EV ready-ON/OFF state, a cooling ON/OFF state, a heating ON/OFF state, and target internal temperature information of the vehicle.

When it is determined that the charging state of the first battery 91 is less than or equal to the first reference SOC value, the driving mode is the eco mode, the heating mode is in an ON state, and the target internal temperature received through the inputter is greater than or equal to the first reference internal temperature, the processor 102 may be configured to determine that switching to the power saving mode is required.

When it is determined that the charging state of the first battery 91 is less than or equal to the first reference SOC value, the driving mode is the eco mode, the cooling mode is in an ON state, and the target internal temperature received through the inputter is less than or equal to the second reference internal temperature, the processor 102 may be configured to determine that switching to the power saving mode is required.

While the power saving mode and the heating mode are in operation, the processor 102 is configured to determine whether the charging state of the first battery 91 is greater than the second reference SoC (first condition), is configured to determine whether the driving mode is a sports mode or a normal mode (second condition), is configured to determine whether the vehicle is in the EV ready-off state (third condition), is configured to determine whether the heating mode is in an OFF state (fourth condition), and is configured to determine whether the target internal temperature received through the inputter 38 is less than the first reference internal temperature (fifth condition). In the present instance, when it is determined that at least one condition is satisfied, the processor 102 may deactivate the power saving mode.

While the power saving mode and the cooling mode are in operation, the processor 102 is configured to determine whether the charging state of the first battery 91 is greater than the second reference SoC (first condition), is configured to determine whether the driving mode is the sports mode or the normal mode (second condition), is configured to determine whether the vehicle is in the EV ready-off state (third condition), is configured to determine whether the cooling mode is in an OFF state (sixth condition), and is configured to determine whether the received target internal temperature is greater than the second reference internal temperature (seventh condition). In the present instance, when it is determined that at least one condition is satisfied, the processor 102 may deactivate the power saving mode.

When the power saving mode is not in operation and the heating mode is in operation, the processor 102 is configured to determine whether the charging state of the first battery 91 is greater than the second reference SoC (first condition), is configured to determine whether the driving mode is the sports mode or the normal mode (second condition), is configured to determine whether the vehicle is in the EV ready-off state (third condition), is configured to determine whether the heating mode is in an OFF state (fourth condition), and is configured to determine whether the target internal temperature received through the inputter 38 is less than the first reference internal temperature (fifth condition). In the present instance, when it is determined that at least one condition is satisfied, the processor 102 may be configured to determine that the power saving mode is not required.

When the power saving mode is not in operation and the cooling mode is in operation, the processor 102 is configured to determine whether the charging state of the first battery 91 is greater than the second reference SoC (first condition), is configured to determine whether the driving mode is the sports mode or the normal mode (second condition), is configured to determine whether the vehicle is in the EV ready-off state (third condition), is configured to determine whether the cooling mode is in an OFF state (sixth condition), and is configured to determine whether the received target internal temperature is greater than the second reference internal temperature (seventh condition). In the present instance, when it is determined that at least one condition is satisfied, the processor 102 may be configured to determine that the power saving mode is not required.

When it is not determined that the power saving mode is required in the cooling mode, the processor 102 may control an output of the compressor so that an internal temperature detected reaches the target internal temperature based on the internal temperature information detected by the internal temperature sensor S1 and the target internal temperature corresponding to a user input.

When it is not determined that the power saving mode is required while in the heating mode, the processor 102 may control an output of the HVAC heater so that an internal temperature detected reaches the target internal temperature based on the internal temperature information detected by the internal temperature sensor S1 and the target internal temperature corresponding to a user input.

When it is not determined that the power saving mode is required, the processor 102 may control an output of the first heating wire 44 based on level information of the first heating wire 44 corresponding to a user input.

When it is not determined that the power saving mode is required, the processor 102 may control an output of the second heating wire 45 based on level information of the second heating wire 45 corresponding to a user input.

When it is not determined that the power saving mode is required, the processor 102 may control an output of the seat ventilation 46 based on level information of the seat ventilation 46 corresponding to a user input.

When it is not determined that the power saving mode is required, the processor 102 may transmit output control information of the first load L1 and the second load L2 corresponding to a user input to the temperature controller 80.

When it is determined that switching to the power saving mode is required in the heating mode, the processor 102 may identify the output of the HVAC heater, which is the first load, and control the output of the HVAC heater to an output lower than the identified output.

When controlling the output of the HVAC heater, the processor 102 may identify an operation rate of the HVAC heater, obtain an operation rate lower than the identified operation rate, and control the output of the HVAC heater to the obtained operation rate.

When it is determined that switching to the power saving mode is required in the heating mode, the processor 102 may identify an operation rate of the first heating wire 44 which is the second load, and control the output of the first heating wire 44 to an output higher than the identified output.

When controlling the output of the first heating wire 44, the processor 102 may identify a target level of the first heating wire 44, and control the output of the first heating wire 44 to a level higher than the identified level.

For example, when a target level of the first heating wire 44 is a first level, the processor 102 may control the first heating wire 44 to a second level or a 1.5^{th} level.

Here, the 1.5^{th} level may be a level having a temperature between a target temperature of the first level and a second target temperature as a target temperature.

In addition to the 1.5^{th} level, the processor 102 may control the first heating wire 44 to a 1.7^{th} level or a 1.9^{th} level.

Also, as an output reduction amount of the HVAC heater increases, increase amount of the first heating wire may further increase.

For example, when the output reduction amount of the HVAC heater is 10%, the processor 102 may control the target level of the first heating wire 44, i.e., the first level, to the 1.5^{th} level, and when the output reduction amount of the HVAC heater is 20%, the processor 102 may control the target level of the first heating wire 44 to the 1.7^{th} level.

In the power saving mode, when it is determined that the first heating wire 44 is in an OFF state, the processor 102 may not control the output of the first heating wire 44.

In the power saving mode, when it is determined that the second heating wire 45 is in an OFF state, the processor 102 may not control the output of the second heating wire 45.

In the power saving mode, when it is determined that the seat ventilation 46 is in an OFF state, the processor 102 may not control the output of the seat ventilation 46.

In the power saving mode, when it is determined that the target level of the first heating wire 44 is the second level which is the highest, the processor 102 may control the output of the first heating wire 44 to the second level.

In the power saving mode, when it is determined that the target level of the second heating wire 45 is the third level which is the highest, the processor 102 may control the output of the second heating wire 45 to the third level.

In the power saving mode, when it is determined that the target level of the seat ventilation 46 is the second level which is the highest, the processor 102 may control the output of the seat ventilation 46 to the second level.

In the power saving mode, when it is determined that switching to the power saving mode is required, the processor 102 may identify the output of the second heating wire 45 which is the second load, and control the output of the second heating wire 45 to an output higher than the identified output.

When controlling the output of the second heating wire 45, the processor 102 may identify a target level of the second heating wire 45, and control the output of the second heating wire 45 to a level higher than the identified level.

When it is determined that switching to the power saving mode is required in the cooling mode, the processor 102 may identify the output of the HVAC compressor which is the first load, and control the output of the HVAC compressor to an output lower than the identified output.

When controlling the output of the HVAC compressor, the processor 102 may identify an operation rate of the HVAC compressor, obtain an operation rate lower than the identified operation rate, and control the output of the HVAC compressor to the obtained operation rate.

When it is determined that switching to the power saving mode is required in the cooling mode, the processor 102 may identify the output of the seat ventilation 46 which is the second load, and control the output of the seat ventilation 46 to an output higher than the identified output.

When controlling the output of the seat ventilation 46, the processor 102 may identify a target level of the seat ventilation 46, and control the output of the seat ventilation 46 to a level higher than the identified level.

For example, when the target level of the seat ventilation 46 is a first level, the processor 102 may control the seat ventilation 46 to a second level.

As an exemplary embodiment of the present disclosure, when the target level of the seat ventilation 46 is a first level, the processor 102 may control the seat ventilation 46 to a 1.5^{th} level.

In the power saving mode, when controlling the outputs of the first load L1 and the second load L2, the processor 102 may control the output of the first load L1 to decrease and control the output of the second load L2 to increase at preset time periods.

The processor 102 may control the output of the first load L1 and the output of the second load L2 to be returned for a duration between a current period and a next period.

The preset time period is a first time period and may be approximately 40 seconds. Also, the duration between two periods is a second time period and may be approximately 4 seconds.

As shown in FIG. 8, when entering the power saving mode while the heating mode is in operation, the processor 102 obtains an output of the HVAC heater based on the internal temperature information detected by the internal temperature sensor S1 and target internal temperature information, and in the present instance, the output of the HVAC heater corresponds to an elapse of a travel time. Also, the processor 102 obtains an output of the second heating wire based on target level information of the second heating wire received through the inputter 38, and in the present instance, the output of the second heating wire corresponds to an elapse of a travel time.

Here, obtaining the output of the HVAC heater over the elapse of the travel time may include obtaining an operation rate of the HVAC heater over travel time.

Obtaining the output of the second heating wire over the elapse of the travel time may include obtaining the amount of power or the amount of current of the second heating wire over travel time.

As shown in FIG. 8, the processor 102 is configured to control the obtained output of the HVAC heater to decrease and is configured to control the output of the second heating wire to increase during a first time period of a first period T11, and when the first time period of the first period T11 elapses, is configured to control the output of the HVAC heater and the output of the second heating wire to be returned during a second time period Tr. When the second time period Tr elapses, the processor 102 is configured to control the obtained output of the HVAC heater to decrease and is configured to control the output of the second heating wire to increase during a first time period of a second period T12. When the first time period of the second period T12 elapses, the processor 102 is configured to control the output of the HVAC heater and the output of the second heating wire to be returned during a second time period Tr.

The processor 102 may directly control the first load and the second load based on output reduction amount of the first load and output increase amount of the second load during the first time period at predetermined time periods.

Furthermore, the processor 102 may identify the first time period to control the outputs of the first load and the second load, and the second time period to return to the obtained outputs of the first load and the second load. Also, the processor 102 may periodically determine the output reduction amount of the first load and the output increase amount of the second load during the first time period, and periodically transmit, to the temperature controller 80, the determined output reduction amount of the first load and the determined output increase amount of the second load during the first time period. That is, the processor 102 may transmit, to the temperature controller 80, output control information corresponding to the output reduction amount of the first load and output control information corresponding to the output increase amount of the second load, together with time information.

The operation of controlling the output of the HVAC heater to decrease and controlling the output of the second heating wire to increase during the first time period of the first period T11 is described with reference to FIG. 9.

As shown in FIG. 9, when entering the power saving mode while the heating mode is in operation, the processor 102 obtains an output of the HVAC heater based on an internal temperature detected by the internal temperature sensor S1 and a target internal temperature set by a user.

When entering the power saving mode while the heating mode is in operation, the processor 102 is configured to determine whether the second heating wire is in an ON state, and when it is determined that the second heating wire is in an ON state, identifies a target level set by the user as an output of the second heating wire.

Controlling the output of the HVAC heater which is the first load and controlling the output of the second heating wire which is the second load during the first period T11 are described.

When entering the power saving mode, the processor 102 decreases an output of the HVAC heater from the obtained output by first reduction amount, and increases an output of the second heating wire from the obtained output by first increase amount, during a first control time TC1.

The first reduction amount may be approximately 10% of the obtained output. The first reduction amount may be approximately 5% of the obtained output.

The first reduction amount may be obtained by experimentation, or selected by the user.

The first increase amount may be a level value between approximately 0.5 and 0.9. For example, when the output of the second heating wire is a second level, the processor 102 may increase the output of the second heating wire to a 2.5 level.

When the first control time TC1 elapses, the processor 102 decreases the output of the HVAC heater from the obtained output by second reduction amount, and increases an output of the second heating wire from the obtained output by second increase amount, during a second control time TC2.

The second reduction amount is greater than the first reduction amount, and may be an output of approximately 20% of the obtained output of the HVAC heater.

The second reduction amount may be an output of approximately 10% of the obtained output. The second reduction amount may be obtained by experimentation, or selected by the user.

The second increase amount is greater than the first increase amount, and may be a level value of approximately one.

For example, when the output of the second heating wire is a second level, the processor 102 may increase the output of the second heating wire to a third level.

When the second control time TC2 elapses, the processor 102 decreases the output of the HVAC heater from the obtained output by the first reduction amount, and increases the output of the second heating wire from the obtained output by the first increase amount, during a third control time TC3.

When the third control time TC3 elapses, the processor 102 may maintain the output of the HVAC heater at the obtained output, and maintain the output of the second heating wire at the obtained output during a fourth control time TC4.

The first to fourth control times may be included in the first period T11.

While the power saving mode is in operation, by repeating an operation of reducing the output of the first load by predetermined reduction amount in stages and increasing the output of the second load by predetermined increase amount in stages, the processor 102 may decrease the total amount of power consumed in the vehicle.

As shown in FIG. 10, a high-voltage HVAC heater utilizes large power because the high-voltage HVAC heater heats air, whereas the second heating wire or the first heating wire utilizes small power because the second heating wire or the first heating wire transfers heat to a contacted user. Accordingly, when the power saving mode is in operation, the total amount of power consumed in the vehicle may be reduced over travel time, increasing a possible driving distance.

The memory 103 may store information related to a target temperature corresponding to each of target levels of the first heating wire, information related to a target temperature corresponding to each of target levels of the second heating wire, and information related to a target air volume corresponding to each of target levels of the seat ventilation.

The memory 103 may store information related to target current amount corresponding to each of target levels of the first heating wire, information related to target current amount corresponding to each of target levels of the second heating wire, and information related to target current amount corresponding to each of target levels of the seat ventilation.

Here, the target current amount of the first heating wire corresponds to an output of the first heating wire, the target current amount of the second heating wire corresponds to an output of the second heating wire, and the target current amount of the seat ventilation corresponds to an output of the seat ventilation.

The memory 103 may also store information related to target current amount corresponding to a control level of the first heating wire, information related to target current amount corresponding to a control level of the second heating wire, and information related to target current amount corresponding to a control level of the seat ventilation.

The control level of the first heating wire is a level adjusted by an output increase control of the first heating wire, and may include at least one of 1.5 level, 1.7 level, or 1.9 level.

The control level of the second heating wire is a level adjusted by an output increase control of the second heating wire, and may include at least one of 1.5 level, 1.7 level, 1.9 level, 2.5 level, 2.7 level, or 2.9 level.

The control level of the seat ventilation is a level adjusted by an output increase control of the seat ventilation, and may include at least one of 1.5 level, 1.7 level, or 1.9 level.

The memory 103 may store a preset period and information related to a time between periods. For example, a time period of the preset period may be a first time period, and approximately 40 seconds. Also, a time between periods may be a second time period, and approximately 4 seconds.

Here, the first time period and the second time period may be times obtained through experiments.

The memory 103 may store information related to the first to fourth control times.

The memory 103 may store information related to the first reduction amount, the second reduction amount, the first increase amount, and the second increase amount.

The memory 103 may store a control temperature corresponding to a target internal temperature, and a display temperature corresponding to the control temperature.

The memory 103 may store the display temperature corresponding to each of control temperatures as a table.

The memory 103 may store information related to a first reference SOC value and a second SoC.

The memory 103 may store information related to a first reference outdoor temperature, a second reference outdoor temperature, a first reference internal temperature and a second reference internal temperature.

The memory 103 may be implemented with at least one of a volatile memory such as a random access memory (RAM), and a non-volatile memory such as a flash memory, a read only memory (ROM), a programmable read only memory (PROM), an erasable programmable read only memory (EPROM), an electrically erasable programmable read only memory (EEPROM), or recording medium such as a Hard Disk Drive (HDD), a compact disc read only memory (CD-ROM), and the like, without being limited thereto.

The memory 103 and the above-described processor 102 may be integrated into one chip, or provided in physically separated locations.

At least one constituent component may be added or omitted corresponding to the performance of the constituent components of the vehicle illustrated in FIG. 2 and the PDC illustrated in FIG. 7. Also, it will be easily understood by those skilled in the art that mutual positions of the constituent components may be modified corresponding to the performance or structure of the vehicle and the PDC 100.

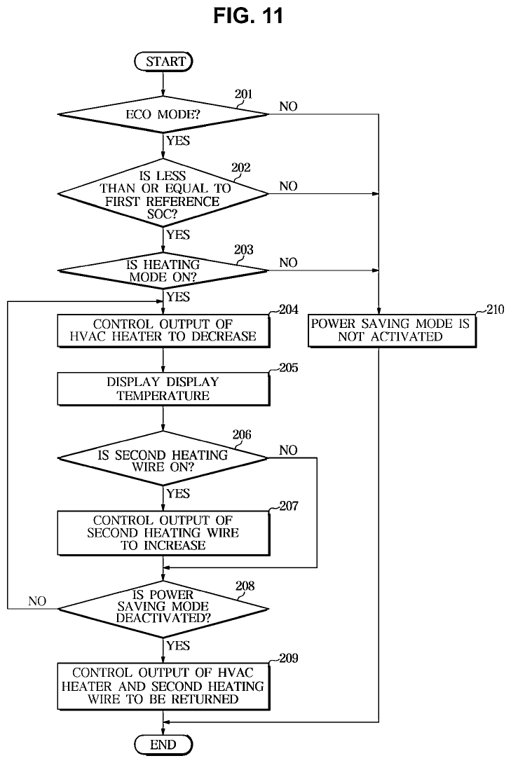

FIG. 11 is a flowchart illustrating a control method of powernet domain controller provided in a vehicle according to an exemplary embodiment of the present disclosure. A case when a heating mode is in operation is described.

The vehicle is configured to determine whether a driving mode is an eco mode (201).

Determining whether a driving mode is an eco mode may include determining whether an ON command of the eco mode has been received through the inputter 38.

The vehicle is configured to determine whether a charging state of the first battery 91 is less than or equal to a first reference SoC (202), and when it is determined that the charging state of the first battery 91 is less than or equal to the first reference SOC value, is configured to determine whether a heating mode is in an ON state (203). When it is determined that the heating mode is in an ON state, the vehicle may enter a power saving mode.

Determining whether the charging state of the first battery 91 is less than or equal to the first reference SoC includes determining whether a charging amount of the first battery is less than or equal to the first reference SoC.

When it is determined that the heating mode is in an ON state, the vehicle is configured to determine whether a target internal temperature received through the inputter 38 is greater than or equal to a first reference internal temperature. When it is determined that the received target internal temperature is greater than or equal to the first reference internal temperature, the vehicle may enter the power saving mode.

When it is determined that the heating mode is in an ON state, the target internal temperature is greater than or equal to the first reference internal temperature, and the vehicle is in an EV ready-on state, the vehicle may enter the power saving mode.

In determining whether the vehicle is in an EV ready-on state, whether power is being supplied to a drive motor may be determined, and when it is determined that power is being supplied to the drive motor, it may be determined that the vehicle is in the EV ready-on state.

When entering the power saving mode while the heating mode is in operation, the vehicle may obtain an output of a heating, ventilation, and air conditioning (HVAC) heater based on target internal temperature information received through the inputter 38 and internal temperature information detected through an internal temperature sensor. Here, obtaining the output of the HVAC heater may include obtaining an operation rate of the HVAC heater.

The vehicle may control the output of the HVAC heater to decrease based on the obtained output of the HVAC heater (204). That is, the vehicle may control an operation of the HVAC heater to an output lower than the obtained output of the HVAC heater.

When controlling the output of the HVAC heater to decrease, the vehicle may periodically control the output of the HVAC heater to decrease.

When periodically controlling the output of the HVAC heater to decrease, the vehicle may control the output of the HVAC heater to decrease during the first time period, while increasing the reduction amount in stages. When the first time period elapses, the vehicle may control the output of the HVAC heater to return to the obtained output during a second time period.

Controlling the output of the HVAC heater to decrease may include controlling the operation rate of the HVAC heater to an operation rate lower than the obtained operation rate.

The vehicle may identify a control temperature corresponding to a target internal temperature based on the target internal temperature information received through the inputter 38, identify a display temperature corresponding to the identified control temperature, and display the identified display temperature on the display 39 (205).

The vehicle may display the identified display temperature through the vehicle terminal 50.

Here, the display temperature is different from the target internal temperature received through the inputter 38 and is different from an internal temperature detected by the internal temperature sensor S1.

The vehicle may control the output of the HVAC heater to decrease until the internal temperature detected by the internal temperature sensor S1 reaches the control temperature.

In the power saving mode, the vehicle may be configured to determine whether the second heating wire is in an ON state (206), and when it is determined that the second heating wire is in an ON state, identify target level information of the second heating wire received through the inputter, and obtain the obtained target level information as an output of the second heating wire.

The vehicle may control the output of the second heating wire to increase based on the target level information (207).

In controlling the output of the second heating wire to increase based on the target level information of the second heating wire, a target level of the second heating wire may be identified based on the target level information of the second heating wire, the identified target level may be increased by a predetermined increase amount, and the output of the second heating wire may be controlled to the increased target level.

In controlling the output of the second heating wire to increase, a target current amount corresponding to the increased target level may be obtained, and the second heating wire may be controlled so that the obtained current amount flows.

In controlling the output of the second heating wire to increase, the output of the second heating wire may be periodically controlled to increase.

When periodically controlling the output of the second heating wire, the vehicle may control the output of the second heating wire to increase during the first time period, while increasing the increase amount in stages. When the first time period elapses, the vehicle may control the output of the second heating wire to return to the obtained output during a second time period.

In the power saving mode, the vehicle may be configured to determine whether the first heating wire is in an ON state, and when it is determined that the first heating wire is in an ON state, identify target level information of the first heating wire received through the inputter 38, and obtain the identified target level information as an output of the first heating wire. Also, the vehicle may control an operation of the first heating wire to an output higher than the obtained output.

In the power saving mode, the vehicle may be configured to determine whether the power saving mode is deactivated (208), and when it is determined that the power saving mode is not in operation, control the outputs of the HVAC heater and the second heating wire to be returned (209).

That is, the vehicle may control the HVAC heater and the second heating wire to the output obtained before the power saving mode is in operation.

In determining whether the power saving mode is deactivated, whether a charging state of the first battery 91 is greater than the second reference SoC is determined (first condition), whether a driving mode is a sports mode or a normal mode is determined (second condition), whether the vehicle is in an EV ready-off state is determined (third condition), whether the heating mode is in an OFF state is determined (fourth condition), and whether the target internal temperature received through the inputter 38 is less than the first reference internal temperature is determined (fifth condition). In the present instance, when it is determined that at least one condition is satisfied, it may be determined that the power saving mode is deactivated.

In determining whether the power saving mode is deactivated, whether the cooling mode is in an OFF state is determined (sixth condition), and whether the received target internal temperature is greater than the second reference internal temperature is determined (seventh condition). In the present instance, when it is determined that at least one condition is satisfied, it may be determined that the power saving mode is deactivated.

When the driving mode is not in the eco mode, the charging state of the battery is greater than or equal to the second reference SOC value, and the heating mode is in an OFF state, the vehicle is configured to determine that switching to the power saving mode is not required and does not activate the power saving mode (210).

When the vehicle is configured to determine that switching to the power saving mode is not required, the vehicle may control the output of the HVAC heater based on the target internal temperature information received through the inputter and the internal temperature information detected through the internal temperature sensor S1. In the present instance, the vehicle may obtain the operation rate of the HVAC heater based on the internal temperature information detected through the internal temperature sensor S1, and control an operation of the HVAC heater based on the obtained operation rate of the HVAC heater.

The vehicle may control the operation of the HVAC heater, until the internal temperature reaches a target internal temperature, based on the internal temperature information detected through the internal temperature sensor S1 and the target internal temperature information.

While the cooling mode is in operation, when the vehicle is configured to determine that switching to the power saving mode is not required, the vehicle may control the output of the HVAC compressor based on the target internal temperature information received through the inputter and the internal temperature information detected through the internal temperature sensor S1. In the present instance, the vehicle may obtain an operation rate of the HVAC compressor based on the target internal temperature information and the internal temperature information detected through the internal temperature sensor S1, and control an operation of the HVAC compressor based on the obtained operation rate of the HVAC compressor.

The vehicle may control the operation of the HVAC compressor, until the internal temperature reaches a target internal temperature, based on the internal temperature information detected through the internal temperature sensor S1 and the target internal temperature information.

When it is determined that switching to the power saving mode is not required, the vehicle is configured to determine whether the first heating wire is in an ON state, and when it is determined that the first heating wire is in an OFF state, does not perform the control of the first heating wire. However, when it is determined that the first heating wire is in an ON state, the vehicle is configured to control the output of the first heating wire based on the target level information of the first heating wire received through the inputter 38. For example, when it is determined that the target level of the first heating wire corresponding to the target level information of the first heating wire is a first level, the vehicle may control current flowing through the first heating wire so that heat at a temperature corresponding to the first level is generated in the first heating wire.

When it is determined that switching to the power saving mode is not required, the vehicle is configured to determine whether the second heating wire is in an ON state, and when it is determined that the second heating wire is in an OFF state, does not perform the control of the second heating wire. However, when it is determined that the second heating wire 45 is in an ON state, the vehicle is configured to control the output of the second heating wire based on the target level information of the second heating wire received through the inputter 38. For example, when it is determined that the target level of the second heating wire corresponding to the target level information of the second heating wire is a first level, the vehicle may control current flowing through the second heating wire so that heat at a temperature corresponding to the first level is generated in the second heating wire.

When it is determined that switching to the power saving mode is not required, the vehicle is configured to determine whether the seat ventilation is in an ON state, and when it is determined that the seat ventilation is in an OFF state, does not perform the control of the seat ventilation. However, when it is determined that the seat ventilation 46 is in an ON state, the vehicle is configured to control the output of the seat ventilation based on the target level information of the seat ventilation received through the inputter 38. For example, when it is determined that the target level of the seat ventilation corresponding to the target level information of the seat ventilation is a second level, the vehicle may control current flowing through the circulation fan of the seat ventilation 46 so that air of air volume corresponding to the second level blows through the circulation fan of the seat ventilation 46.

As is apparent from the above, according to the exemplary embodiments of the present disclosure, when a power saving mode is in operation, an output of an HVAC may be reduced and an output of a first heating wire, a second heating wire, or a seat ventilation may be increased, preventing user discomfort.

According to the exemplary embodiments of the present disclosure, when a power saving mode is in operation, a display temperature corresponding to a target internal temperature may be displayed, preventing a user from recognizing a decrease in output of an HVAC.

According to the exemplary embodiments of the present disclosure, a power saving performance may be enhanced due to a decrease in output of an HVAC, and a possible driving distance may be increased due to a decrease in power consumption.

According to the exemplary embodiments of the present disclosure, a power state of an entire vehicle may be stabilized and a fuel efficiency (energy efficiency) of the vehicle may be improved.

According to the exemplary embodiments of the present disclosure, a marketability and competitiveness of vehicle may be enhanced due to improved user convenience and satisfaction.

Meanwhile, embodiments may be stored in the form of a recording medium storing computer-executable instructions. The instructions may be stored in a form of a program code, and when executed by a processor, the instructions may perform operations of the disclosed exemplary embodiments of the present disclosure. The recording medium may be implemented as a non-transitory computer-readable recording medium.

The non-transitory computer-readable recording medium includes all kinds of recording media in which instructions which may be decoded by a computer are stored of, for example, a read only memory (ROM), random access memory (RAM), magnetic tapes, magnetic disks, flash memories, optical recording medium, and the like.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A powernet domain controller, comprising:
a communicator configured to communicate with a battery management system managing a state of charge (SOC) value of a battery;
a processor electrically connected to the communicator and configured for determining whether to activate a power saving mode based on the SoC value received through the communicator, and when the power saving mode is activated, control an output of a high-voltage load to decrease and control an output of a low-voltage load to increase.

2. The powernet domain controller of claim 1,
wherein the high-voltage load is a load to which a voltage greater than or equal to a first voltage is applied,
wherein the low-voltage load is a load to which a voltage less than or equal to a second voltage is applied, and
wherein the second voltage is less than the first voltage.

3. The powernet domain controller of claim 1,
wherein the communicator is further configured to communicate with an inputter receiving a user input, and
wherein the processor is further configured to:
identify a target internal temperature received through the inputter,
identify an operation rate of the high-voltage load corresponding to the identified target internal temperature,
control the high-voltage load to operate at an operation rate lower than the identified operation rate of the high-voltage load,
identify a target level of the low-voltage load received through the inputter, and
control the low-voltage load to operate at an operation rate higher than the identified target level.

4. The powernet domain controller of claim 1, further including:
a memory configured to store information related to a control temperature corresponding to each of target internal temperatures,
wherein the communicator is further configured to communicate with an inputter and an internal temperature sensor, and
wherein in the power saving mode, the processor is further configured to:
identify a control temperature corresponding to a target internal temperature received through the inputter based on information stored in the memory,
obtain an operation rate of the high-voltage load based on the identified control temperature and an internal temperature detected by the internal temperature sensor, and
control the high-voltage load based on the obtained operation rate.

5. The powernet domain controller of claim 4, wherein the processor is further configured to identify a target level of the low-voltage load received through the inputter, and control the low-voltage load to operate at an operation rate higher than the identified target level.

6. The powernet domain controller of claim 4,
wherein the memory is configured to further store information related to a display temperature corresponding to each of control temperatures,
wherein the communicator is further configured to communicate with a display, and
wherein the processor is further configured to identify a display temperature corresponding to the identified control temperature based on the information stored in the memory, and transmit a display command for the identified display temperature to the display.

7. The powernet domain controller of claim 1,
wherein the communicator is further configured to communicate with an inputter receiving a user input, and
wherein the processor is further configured to control to enter the power saving mode, based on the SoC value being less than or equal to a first reference SOC value, an economical mode (eco mode) being received through the inputter, a heating mode being received through the inputter, and a target internal temperature received through the inputter being greater than or equal to a first reference internal temperature.

8. The powernet domain controller of claim 1,
wherein the communicator is further configured to communicate with an inputter receiving a user input, and
wherein the processor is further configured to control to enter the power saving mode, based on the SoC value being less than or equal to a first reference SOC value, an eco mode being received through the inputter, a cooling mode being received through the inputter, and a target internal temperature received through the inputter being less than or equal to a second reference internal temperature.

9. The powernet domain controller of claim 1, wherein the processor is further configured to:
in the power saving mode, control the output of the high-voltage load to decrease, and control the output of the low-voltage load to increase during a first time period, and
based on the first time period having elapsed, control the output of the high-voltage load and the output of the low-voltage load to be returned during a second time period.

10. A vehicle, comprising:
a first load configured to be applied with a first voltage;
a second load configured to be applied with a second voltage lower than the first voltage;
a temperature controller configured to control an operation of the first load and the second load;
an inputter configured to receive a user input;
a battery management system configured to manage a state of charge (SOC) value of a battery; and
a powernet domain controller configured for determining whether to activate a power saving mode based on the SoC value, and when the power saving mode is activated, transmit an output reduction command of the first load and an output increase command of the second load to the temperature controller.

11. The vehicle of claim 10,
wherein the first load includes a compressor and a heater of an air conditioner, and
wherein the second load includes at least one of a first heating wire provided in a steering wheel, a second heating wire provided in at least one seat, or a seat ventilation provided in the at least one seat.

12. The vehicle of claim 11, wherein the temperature controller is configured to control the air conditioner to adjust an internal temperature, control the first heating wire to adjust a temperature of the steering wheel, and control the second heating wire or the seat ventilation to adjust a temperature of the at least one seat.

13. The vehicle of claim 10, wherein the powernet domain controller is further configured to:
identify a target internal temperature received through the inputter,
identify an operation rate of the first load corresponding to the identified target internal temperature,
transmit an operation rate lower than the identified operation rate of the first load as an output control information of the first load to the temperature controller,
identify a target level of the second load received through the inputter, and
transmit a level higher than the identified target level as an output control information of the second load to the temperature controller.

14. The vehicle of claim 10, further including:
an internal temperature sensor configured to detect an internal temperature; and
a memory configured to store information related to a control temperature corresponding to each of target internal temperatures,
wherein, in the power saving mode, the powernet domain controller is configured to:
identify a control temperature corresponding to a target internal temperature received through the inputter based on the information stored in the memory,
obtain an operation rate of a first load based on the identified control temperature and the internal temperature detected by the internal temperature sensor, and
transmit the obtained operation rate as an output control information to the temperature controller.

15. The vehicle of claim 14, wherein the powernet domain controller is configured to identify a target level of a second load received through the inputter, and transmit a level higher than the identified target level as an output control information of the second load to the temperature controller.

16. The vehicle of claim 14, further including:
a display;
wherein the memory is configured to further store information related to a display temperature corresponding to each of control temperatures, and
wherein the powernet domain controller is further configured to identify a display temperature corresponding to the identified control temperature based on the information stored in the memory, and control the display to display the identified display temperature.

17. The vehicle of claim 10, further including:
a drive motor configured to be connected to a wheel and be supplied with power from the battery,
wherein the powernet domain controller is further configured to:
determine whether the vehicle is in an electric vehicle (EV) ready-on state or an EV ready-off state based in a state of the drive motor, and
in a heating mode, control to enter the power saving mode, based on the SoC value being less than or equal to a first reference SOC value, an economical mode (eco mode) being received through the inputter, the EV ready-on state being in operation, and a target internal temperature received through the inputter being greater than or equal to a first reference internal temperature.

18. The vehicle of claim 17, wherein the powernet domain controller is further configured to:
in a cooling mode, control to enter the power saving mode, based on the SoC value being less than or equal to the first reference SOC value, the eco mode being received through the inputter, the EV ready-on state being in operation, and the target internal temperature received through the inputter being less than or equal to a second reference internal temperature.

19. The vehicle of claim 18, wherein the powernet domain controller is further configured to:
in the power saving mode, turn off the power saving mode, based on the SoC value being greater than or equal to a second reference SOC value, a normal mode or a sports mode being received through the inputter, the EV ready-off state being in operation, the target internal temperature received through the inputter being greater than the second reference internal temperature, or the target internal temperature received through the inputter being less than the first reference internal temperature.

20. The vehicle of claim 10, wherein the powernet domain controller is further configured to:
in the power saving mode, transmit an output reduction command of the first load and an output increase command of the second load to the temperature controller during a first time period, and
based on the first time period having elapsed, transmit an output return command of the first load and an output return command of the second load to the temperature controller during a second time period.
